(19) United States
(12) Patent Application Publication
(10) Pub. No.: US 2003/0192349 A1
(43) Pub. Date: Oct. 16, 2003

(54) Method for controlling fusion pipe sag

(75) Inventors: Gautam Meda, Corning, NY (US); William R. Powell, Horseheads, NY (US); Randy L. Rhoads, Horseheads, NY (US)

Correspondence Address: Maurice M. Klee, Ph. D., 1951 Burr Street, Fairfield, CT, 06824, US

(73) Assignee: CORNING INCORPORATED

(21) Appl. No.: 10/412,112

(22) Filed: Apr. 11, 2003

Related U.S. Application Data
(60) Provisional application No. 60/372,188, filed on Apr. 12, 2002.

(51) Int. Cl. C03B 17/06

(52) U.S. Cl. 65/53; 65/195

(57) ABSTRACT

The sag rate of fusion pipes (e.g., isopipes (13) used in an overflow downdraw fusion process) is reduced by the application of axial forces (F) to the end regions (23) of the pipe. The axial forces are applied to the end regions below the pipe's neutral axis (19) so that a bending moment is generated which opposes gravitational sagging of the middle of the pipe. The use of such sag-controlling axial forces increases pipe service life by, for example, at least a third.

### FIELD OF THE INVENTION

This invention relates to fusion pipes used in the production of sheet glass and, in particular, to techniques for controlling the sag which such pipes exhibit during use.

### BACKGROUND OF THE INVENTION

The fusion process is one of the basic techniques used in the glass making art to produce sheet glass. See, for example, Varshneya, Arun K., “Flat Glass,” Fundamentals of Inorganic Glasses, Academic Press, Inc., Boston, 1994, Chapter 20, Section 4.2., 534-540. Compared to other processes known in the art, e.g., the float and slot draw processes, the fusion process produces glass sheets whose surfaces have superior flatness and smoothness. As a result, the fusion process has become of particular importance in the production of the glass substrates used in the manufacture of liquid crystal displays (LCDs).

The fusion process, specifically, the overflow downdraw fusion process, is the subject of commonly assigned U.S. Pat. Nos. 3,338,696 and 3,682,609, to Stuart M. Dockerty, the contents of which are incorporated herein by reference. A schematic drawing of the process of these patents is shown In FIG. 1. As illustrated therein, the system includes a supply pipe 9 which provides molten glass to a collection trough 11 formed in a refractory body 13 known as an overflow downdraw fusion pipe or, more simply, a “fusion pipe.”

Once steady state operation has been achieved, molten glass passes from the supply pipe to the trough and then overflows the top of the trough on both sides, thus forming two sheets of glass that flow downward and then inward along the outer surfaces of the fusion pipe. The two sheets meet at the bottom or root 15 of the pipe, where they fuse together into a single sheet. The single sheet is then fed to drawing equipment (represented schematically by arrows 17), which controls the thickness of the sheet by the rate at which the sheet is drawn away from the root. The drawing equipment is located well downstream of the root so that the single sheet has cooled and become rigid before coming into contact with the equipment.

As can be seen in FIG. 1, the outer surfaces of the final glass sheet do not contact any part of the outside surface of the fusion pipe during any part of the process. Rather, these surfaces only see the ambient atmosphere. The inner surfaces of the two half sheets which form the final sheet do contact the pipe, but those inner surfaces fuse together at the root of the pipe and are thus buried in the body of the final sheet. In this way, the superior properties of the outer surfaces of the final sheet are achieved.

As is evident from the foregoing, fusion pipe 13 is critical to the success of the fusion process. In particular, the dimensional stability of the fusion pipe is of great importance since changes in pipe geometry affect the overall success of the process. Unfortunately, the conditions under which the fusion pipe is used make it susceptible to dimensional changes.

Thus, the fusion pipe must operate at elevated temperatures on the order of 1000° C. and above. Moreover, in the case of the overflow downdraw fusion process, the pipe must operate at these elevated temperatures while supporting its own weight as well as the weight of the molten glass overflowing its sides and in trough 11, and at least some tensional force that is transferred back to the pipe through the fused glass as it is being drawn. Depending on the width of the glass sheets that are to be produced, the pipe can have an unsupported length of 1.5 meters or more.

To withstand these demanding conditions, fusion pipes 13 have been manufactured from various high performance refractory materials. For example, fusion pipes have been made from isostatically pressed blocks of refractory material and thus are sometimes referred to as “iso-pipes”. In particular, isostatically pressed zircon refractories have been used to form isopipes for the fusion process.

Even with such high performance materials, in practice, fusion pipes exhibit dimensional changes which limit their useful life. In particular, such pipes exhibit sag such that the middle of the unsupported length of the pipe drops relative to its outer supported ends. The present invention is concerned with controlling such sag.

### DESCRIPTION OF THE PRIOR ART

Overman, U.S. Pat. No. 3,437,470, discloses a fusion pipe having a longitudinally extending aperture formed in the body of the pipe for receiving a support bar. The support bar acts as a lever with one end being subject to an upward force and the other end serving as a pivot. The support bar contacts the upper wall of the aperture around the middle of the fusion pipe and through such contact, applies an upward force to the pipe.

Japanese Patent Publication No. 11-246230 shows a variation of the Overman patent where again a longitudinally extending aperture is formed in the body of the fusion pipe for receiving a support bar. In this case, the support bar is not pivoted, but rather engages and applies an upward force to the upper wall of the aperture along essentially its entire length. According to this patent publication, the support bar should be made of a material whose Young's modulus and flexural strength are greater than that of the material used to produce the fusion pipe.

Both of these approaches suffer from the basic problem that an aperture in a fusion pipe weakens the pipe, which makes it more prone to sagging and can lead to other problems, e.g., crack formation, under the demanding environmental conditions in which fusion pipes are used. As discussed in detail below, the present invention achieves sag control through the application of external forces and thus does not require compromising the integrity of the pipe.

### SUMMARY OF THE INVENTION

In view of the foregoing, it is an object of this invention to provide methods for controlling the sag of fusion pipes. More specifically, the invention provides methods for reducing the sag rate of a fusion pipe and, in particular, the sag rate in the region of the middle of the pipe where the largest amount of sag is normally observed.

To achieve the above objects, the invention provides a method for reducing the sag rate of a fusion pipe (13) comprising applying equal and opposite axial forces (F) to portions of the end regions (23) of the pipe such that the axial forces generate a bending moment in the middle region of the pipe whose sense is such as to oppose gravitational sagging of that region.

Preferably, the portions of the end regions at which the axial forces are applied are selected by identifying a neutral axis or surface for the pipe (e.g., by computer modeling of the configuration of the pipe), and locating the portions below that axis or surface.

In certain preferred embodiments of the invention, the axial force applied to one end of the pipe is an active force (e.g., from an air cylinder, one or more springs, or similar devices or combinations of devices) and the axial force applied to other end is a reactive force (i.e., a force resulting from the fixation of that end).

In practice, the invention can achieve reductions in a fusion pipe's sag rate of at least 25% compared to a pipe which does not use the invention. As a consequence of the reduced sag, the service life of the pipe can be increased by at least a third (33%).

Additional features and advantages of the invention will be set forth in the detailed description which follows, and in part will be readily apparent to those skilled in the art from that description or recognized by practicing the invention as described herein. It is to be understood that both the foregoing general description and the following detailed description are merely exemplary of the invention, and are intended to provide an overview or framework for understanding the nature and character of the invention as claimed.

The accompanying drawings are included to provide a further understanding of the invention, and are incorporated in and constitute a part of this specification. The drawings illustrate various aspects of the invention, and together with the description serve to explain the principles and operation of the invention.

### BRIEF DESCRIPTION OF THE DRAWINGS

FIG. 1 is a schematic drawing illustrating a representative construction for a fusion pipe for use in an overflow downdraw fusion process for making flat glass sheets.

FIG. 2 is a schematic drawing illustrating the off-center axial forces used to control sag in accordance with the invention.

### DETAILED DESCRIPTION OF THE INVENTION

As discussed above, in the overflow process for making glass sheet, hot glass flows into a trough 11 formed in a fusion pipe 13 and then flows over the top of the trough (the top of the weirs) and down the sides of the pipe to the root 15 of the pipe where it is drawn off as sheet glass.

Because of the high temperatures at which the process operates, the material of the pipe is susceptible to creep. Hence, the pipe sags steadily under gravity. Eventually the sag reaches a point where the quality and/or the dimensions of the finished glass are no longer within specifications and the pipe needs to be taken out of service and replaced. It is accordingly desirable to reduce the sag rate of the pipe, and thereby extend its useful life.

The present invention achieves reduction in sag through the use of axial forces which apply favorable moments at the ends of the pipe which reduce the sag of the pipe due to gravity. FIG. 2 is a schematic drawing of the applied axial forces and the relevant pipe geometry. In this figure, pipe 13 is supported at its ends by supports 21 and has a neutral axis 19. The neutral axis is that axis which does not elongate or contract as pipe 13 undergoes bending based on its mass distribution, its temperature distribution, and its material properties as a function of temperature. Put another way, the neutral axis is that axis which would not elongate or contract if pipe 13 were to undergo bending in the absence of axial forces F of FIG. 2 but with all other conditions the same.

The neutral axis is actually a neutral surface. See, for example, Snyder et al., Engineering Mechanics: Statics and Strength of Materials, McGraw-Hill, New York, 1973, 349-350. However, because fusion pipe 13 is typically and preferably symmetric about a longitudinal vertical plane through root 15 (hereinafter referred to as the “frontal plane”) and because the sag-controlling axial forces of the invention are also preferably symmetric with respect to that plane, for ease of presentation, the invention is discussed herein in terms of a neutral axis located in the frontal plane. It is to be understood, of course, that the description of the invention in these terms is not intended to and should not be interpreted as limiting the invention in any manner.

As shown in FIG. 2, axial forces F are applied to fusion pipe 13 at a distance H below neutral axis 19. Accordingly, the axial forces produce end moments of magnitude FH at the ends of the pipe. The sense of these moments is such that they reduce the tendency of the pipe to sag under the force of gravity. The moments produced by the axial forces will not eliminate all deformation of the pipe, but as illustrated by the comparative example presented below, a suitable choice of F and H will significantly prolong the useful life of the pipe.

Particular values for F and H will depend on the specific geometry of the fusion pipe, the thermal distribution of the pipe, the material properties of the pipe as a function of temperature, the glass load carried by the pipe, and the forces transmitted back to the pipe by the drawing of the glass sheet, as well as on the locations 21 at which the pipe is supported and the portions of end regions 23 at which the axial forces are applied. In practice, candidate values for F and H are preferably found by performing finite element computer modeling of the fusion pipe when subject to these forces and the temperatures the pipe is expected to experience during use. Such modeling can be performed using, for example, the commercially available ANSYS software sold by ANSYS Inc., 275 Technology Drive, Canonsburg, Pa. 15317, USA. (The ANSYS software can also be used to determine the location of the neutral axis for complex fusion pipe shapes.)

In doing this modeling, the creep rate of the material making up the fusion pipe (i.e., [symbol] =dε/dt, where ε is strain and t is time) is preferably represented by a power law expression of the following form:

[symbol]

=Aσⁿ exp(Q/T),

where T is temperature, σ is the applied stress, and A, n, and Q are material dependent constants. See Kingery et al., “Plastic Deformation, Viscous Flow, and Creep,” Introduction to Ceramics, 2^{nd} edition, John Wiley & Sons, New York, 1976, 704-767 and, in particular, equation 14.9.

In addition to modeling the sag of the fusion pipe, it is also important to model the axial contraction of the pipe due to material creep that will result from the application of the sag-controlling axial forces. Such axial contraction also represents a change in the geometry of the fusion pipe and thus can have adverse effects on the quality and/or the dimensions of the finished glass. In practice, the sag-controlling axial force needs to be selected to provide a balance between reducing sag without causing excessive axial contraction.

Upon completion of the modeling process, candidate F and H values can be tested on actual fusion pipes under use conditions with adjustments being made as appropriate based on the observed performance of the pipe. The axial forces can be applied using various force-generating techniques, a preferred technique being through the use of an air cylinder on one end of the pipe with the other end being held fixed. One or more springs, either alone or in combination with an air cylinder, can also be used for this purpose.

Although computer modeling prior to putting the invention into practice is preferred, the magnitude and locations of axial forces suitable for reducing sag without generating excessive axial contraction can be determined entirely empirically if desired.

Without intending to limit it in any manner, the present invention will be more fully described by the following example.

### COMPARATIVE EXAMPLE

Overflow downdraw fusion pipes composed of isostatically pressed zircon were tested under service conditions with and without the application of sag-controlling axial forces.

In these experiments, the fusion pipe was symmetric about the frontal plane and the sag-controlling forces were also symmetric about that plane. Specifically, the sag-controlling forces were applied substantially uniformly to corresponding areas at the ends of the pipe, the centers of which were at the frontal plane.

The force was applied to one end of the pipe using an air cylinder with the other end held stationary. The magnitude of the force generated by the air cylinder was approximately 33,000 newtons and was centered at a point approximately 12 centimeters below the neutral axis. The fixation of the opposite end of the pipe was centered the same distance below the neutral axis. The moments applied to the ends of the pipe were thus each approximately 4,000 newton-meters. The magnitude of the force applied to the pipe was monitored using a load cell. Alternatively, the force can be monitored by inserting a spring of known spring constant in the force-applying train and using a LVDT (linear variable differential transformer) to determine the length of the spring and thus the force applied to the pipe.

The use of the sag-controlling forces was found to result in a reduction in the rate of sag at the middle of the pipe of approximately 80%. Some axial contraction of the pipe was observed as a result of the application of the axial forces, but the contraction did not significantly compromise the service life of the pipe. Rather, the use of the sag-controlling forces was found to increase service life by approximately 400%.

Although specific embodiments of the invention have been described and illustrated, it is to be understood that modifications can be made without departing from the invention's spirit and scope. For example, although it is preferred that the fusion pipe does not include an aperture for an internal support bar (see U.S. Pat. No. 3,437,470 and Japanese Patent Publication No. 11-246230 discussed above), fusion pipes with such an aperture will benefit from sag-controlling axial forces and thus the invention can be used with such pipes if desired.

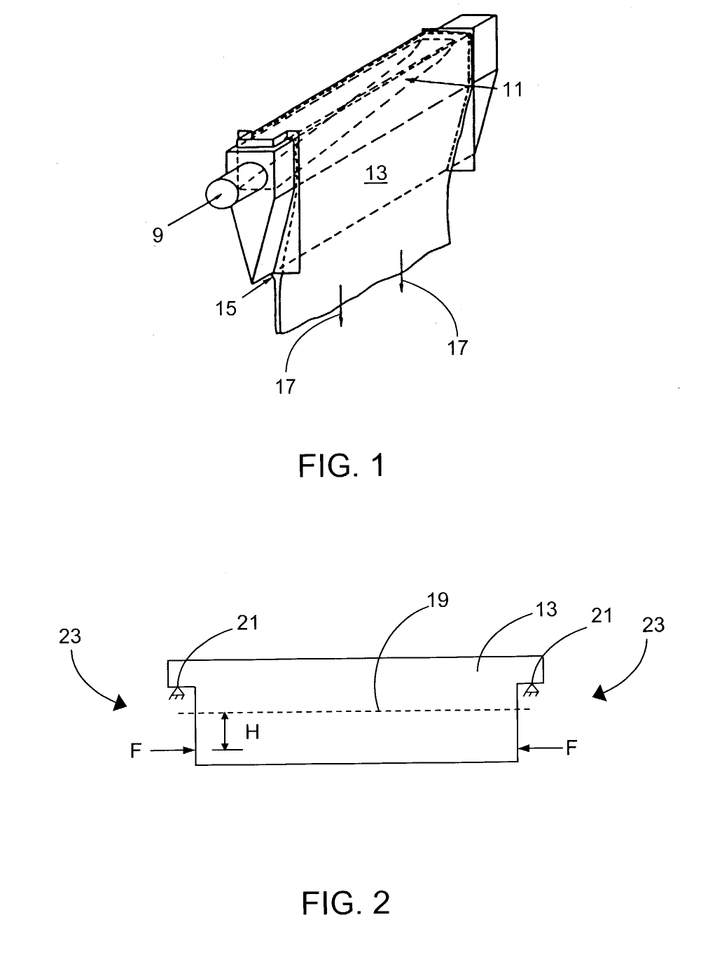

Similarly, although the invention has been discussed and illustrated in terms of unitary fusion pipes having configurations of the general type shown in FIG. 1 and FIG. 2, the invention can be used with fusion pipes having a variety of other configurations and/or composed of more than one element. Along these same lines, although the invention has been discussed primarily in terms of fusion pipes and sag-controlling forces which exhibit symmetry about a frontal plane, using the principles discussed herein, the invention can be practiced with pipes and/or sag-controlling forces which lack such symmetry.

A variety of other modifications which do not depart from the scope and spirit of the invention will be evident to persons of ordinary skill in the art from the disclosure herein. The following claims are intended to cover the specific embodiments set forth herein as well as such modifications, variations, and equivalents.

What is claimed is:

1. A method for reducing the sag rate of a fusion pipe, said pipe having a longitudinal axis, a middle region, and end regions, said method comprising supporting the pipe at its end regions and applying equal and opposite axial forces to portions of the end regions, said portions being selected so that the axial forces generate a bending moment in the middle region of the pipe whose sense is such as to oppose gravitational sagging of that region.

2. The method of claim 1 wherein the portions of the end regions are selected by identifying a neutral axis or surface for the pipe and locating the portions below that axis or surface.

3. The method of claim 2 wherein the neutral axis or surface is identified by computer modeling of the pipe.

4. The method of claim 1 wherein candidate axial forces and candidate locations for the portions of the end regions are identified by computer modeling.

5. The method of claim 4 wherein the computer modeling is finite element computer modeling.

6. The method of claim 1 wherein the axial force applied to the portion of one end region is an active force and the axial force applied to the portion of the other end region is a reactive force.

7. The method of claim 6 wherein the active force is generated by an air cylinder and/or one or more springs.

8. The method of claim 1 wherein the magnitude of the equal and opposite axial forces applied to the pipe is monitored.

9. The method of claim 1 wherein the application of the axial forces reduces the sag rate of the pipe by at least 25%.

10. The method of claim 1 wherein the application of the axial forces increases the service life of the pipe by at least a third.
